(19) United States
(12) Patent Application Publication
(10) Pub. No.: US 2007/0076232 A1
(43) Pub. Date: Apr. 5, 2007

(54) Microscope system and method for shading correction of lenses present in the microscope system

(75) Inventors: Frank Olschewski, Heidelberg (DE); Jochen Nickel, Mannheim (DE); William Hay, Heppenheim (DE)

Correspondence Address: DARBY & DARBY P.C., P. O. BOX 5257, NEW YORK, NY, 10150-5257, US

(73) Assignee: Leica Microsystems CMS GmbH, Wetzlar (DE)

(21) Appl. No.: 10/597,555

(22) PCT Filed: Dec. 22, 2004
(86) PCT No.: PCT/EP04/53659

§ 371 Date: Jul. 28, 2006

(30) Foreign Application Priority Data
Jan. 28, 2004 (DE) 10-2004-004 115.6

(51) Int. Cl. H04N 1/60

(52) U.S. Cl. 358/1.9; 359/368

(57) ABSTRACT

A microscope system includes at least one lens that defines an illumination field and at least one light source that emits an illuminating light beam for illuminating a specimen through the lens. At least one detector is provided for, pixel-by-pixel, detecting a detection light beam coming from the specimen. An electronic circuit is connected downstream from the detector, the electronic circuit including a memory unit for storing a wavelength-dependent brightness distribution of an illumination field of the at least one lens. The electronic circuit employs, pixel-by-pixel, the stored wavelength-dependent brightness distribution so as to form a homogeneously illuminated image field. An actuatable element is provided for controlling, pixel-by-pixel, an intensity of the illuminating light beam as a function of the stored wavelength-dependent brightness distribution so as to homogeneously illuminate the illumination field.

### CROSS-REFERENCE TO PRIOR APPLICATION

The above-referenced application is the U.S. National Phase of International Patent Application PCT/EP2004/053659, filed Dec. 22, 2004, which claims priority to German Application No. 10 2004 004 115.6, filed Jan. 28, 2004, which is incorporated by reference herein. The International application was published in German on Aug. 11, 2005 as WO 2005/073776 A1.

### FIELD OF THE INVENTION

The invention relates to a microscope system. In particular, the invention relates to a microscope system with at least one lens that is present in the microscope system and that defines an illumination field, with at least one light source that emits an illuminating light beam that illuminates a specimen through the lens, with at least one detector that, pixel-by-pixel, detects a detection light beam coming from the specimen, with an electronic circuit located downstream from the detector and having a memory unit in which a wavelength-dependent brightness distribution of the illumination field of the lenses present in the microscope system is saved.

Moreover, the invention relates to a method for the shading correction of at least one lens that is present in the microscope system and that defines an illumination field, comprising at least one light source that emits an illuminating light beam that illuminates a specimen through the lens and comprising at least one detector.

### BACKGROUND

U.S. Pat. No. 6,355,919 discloses a method for calibrating a scanning microscope. Here, the calibration of the scanning microscope can be carried out as often as desired. The calibration means are arranged in a plane of an intermediate image and can be scanned by the scanning light beam. The calibration means are arranged outside the actual image field and are configured as reference structures. However, this does not allow a compensation of the image field curvature.

### SUMMARY

It is an object of the present invention to provide a microscope system with which an image and an illumination can be implemented in order to compensate for a correction of the edge shading caused by the image field curvature.

It is another, alternative object of the present invention to provide a method with which shading effects of the lens of a microscope system can be eliminated.

In an embodiment the present invention provides a microscope system having at least one lens that is present in the microscope system and that defines an illumination field. Furthermore, at least one light source is provided in the microscope system so as to emit an illuminating light beam that illuminates a specimen through the lens. By the same token, at least one detector is present that, pixel-by-pixel, detects a detection light beam coming from the specimen. An electronic circuit downstream from the detector serves to process the image data captured by the detector. A wavelength-dependent brightness distribution of the illumination field of the lenses present in the microscope system is saved in a memory unit. An actuatable element is provided in the illuminating light beam and it controls the intensity of the illuminating light beam pixel-by-pixel as a function of the stored, wavelength-dependent brightness distribution in such a way that the illumination field is homogeneously illuminated. The electronic circuit employs the saved wavelength-dependent brightness distribution pixel-by-pixel in such a way that a homogeneously illuminated image field is formed.

The actuatable element in the illuminating light beam is an LCD matrix whose individual pixels are actuated according to the stored, wavelength-dependent brightness distribution. In one embodiment, the detector is a CCD chip.

In another embodiment, a scanning device is provided in the illuminating light beam of the microscope system and it conducts the illuminating light beam pixel-by-pixel over or through the specimen. The actuatable element in the illuminating light beam is an acousto-optic element that can be actuated as a function of the wavelength-dependent brightness distribution saved in the memory unit in such a way that the illumination field consisting of the individual pixels has a homogeneous brightness distribution. The acousto-optic element is an AOTF (Acousto-Optic Tunable Filter) or an AOBS (Acousto-Optic Beam Splitter) or an AOM (Acousto-Optic Modulator).

The microscope system can be equipped with different light sources such as, for example, a laser, a multiline laser or a laser that emits a continuous wavelength spectrum.

If a laser is used with the scanning device, the detector of the microscope system comprises at least one light-sensitive element that serially captures the pixels of the illumination field on the specimen. The electronic circuit combines the individual pixels to form an image field that can be computed with the appropriate wavelength-dependent brightness distribution.

In an embodiment the present invention provides a method for the shading correction including the following steps:
saving the wavelength-dependent brightness distribution in a RAM table;
pixel-by-pixel actuation of an element with a wavelength-dependent brightness distribution of the illumination field of the lens in such a way that the illumination field is homogeneously illuminated;
pixel-by-pixel detection of the detection light beam coming from the specimen; and
employing the wavelength-dependent brightness distribution of the illumination field of the lens in order to compute the image field captured with the lens.

### BRIEF DESCRIPTION OF THE DRAWINGS

The present invention is elaborated upon below based on exemplary embodiments with reference to the drawings which show:

FIG. 1 a schematic depiction of a microscope with an actuatable element in the illuminating light beam;

FIG. 2 a schematic depiction of a scanning microscope with an actuatable element in the illuminating light beam;

FIG. 3 a schematic depiction of another embodiment of the scanning microscope with a control circuit for changing the intensity of the illuminating light beam coming from the light source;

FIG. 4a a schematic depiction of the brightness distribution for an image field;

FIG. 4b a schematic depiction of the brightness distribution for an illumination field;

FIG. 5 a schematic depiction of a surface sensor for capturing the detection light beam coming from the specimen; and

FIG. 6 a schematic depiction of the actuatable element with which the individual pixels are actuated according to the brightness distribution for a wavelength.

### DETAILED DESCRIPTION

FIG. 1 schematically shows a microscope system 1. The embodiment of the microscope system shown here comprises a reflected light microscope. It goes without saying that the microscope system 1 can likewise comprise a transmitted light microscope or a configuration with which it is possible to switch between both types of light. The schematic depiction of the microscope only shows those components that are relatively important to the description. All of the other elements or components such as, for example, the stand, the revolving nosepiece, the tube, the eyepiece, the camera, the camera tube, etc. are sufficiently familiar to a person skilled in the art and hence do not have to be mentioned here explicitly. The microscope comprises at least one light source 3 that emits an illuminating light beam 5 that is depicted in FIG. 1 as a solid line. In the embodiment shown here, a beam deflection means 7 is provided that deflects the illuminating light beam 5 onto a lens 9 located in the working position. The lens 9 is positioned above a specimen 10 that, in turn, is located on a microscope slide 11. It is sufficiently familiar to a person skilled in the art that the microscope slide 11 can be positioned on a movable stage. The embodiment shown here is a reflected light microscope so that the light coming from the specimen 10 is imaged by the lens 9 onto at least one detector 20. The detector 20 and the lens 9 are arranged in the detection light beam 12. The detection light beam 12 is shown as a broken line. In the case of a lens, a so-called lens system, if one leaves aside all aberrations such as, for instance, astigmatism, longitudinal chromatic aberrations, transverse chromatic aberrations, etc., then only one curved surface is always imaged onto another curved surface. This is also referred to as image field curvature. This phenomenon applies to individual objectives as well as to entire microscope systems and leads to a shading effect in the captured images. FIG. 4a shows an image field 40. Each image field 40 becomes darker and darker as measured starting from a mid-point 41, that is to say, the intensity of the captured image field 40 or else the intensity of the illumination field decreases from the mid-point 41 towards the outside. This drop in intensity from the mid-point 41 towards the outside is likewise dependent on the wavelength. The image field 40 is, for example, rectangular and the intensity decreases towards a first and second long sides 42a and 42b respectively, and towards a first and second short sides 43a and 43b. An actuatable element 13 is provided in the illuminating light beam 5 and in the detection light beam 12. The actuatable element 13 is connected to an electronic circuit 14 that is provided with a memory unit 15. A wavelength-dependent brightness distribution such as, for example, in FIG. 4a of the illumination field of the lenses 9 present in the microscope system is saved in the memory unit 15. By the same token, the electronic circuit 14 can also be connected to the lens 9 or to the revolving nosepiece, so that the electronic circuit 14 continuously receives information about the lens 9 that is momentarily located in the illuminating light beam or in the detection light beam. It is clear to any person skilled in the art that different lenses exhibit different shading. The electronic circuit 14 serves to control the intensity of the illuminating light beam 5 pixel-by-pixel as a function of the stored wavelength-dependent brightness distribution. The actuatable element 13 is controlled with the stored wavelength-dependent brightness distribution in such a way that the illumination field 46 (see FIG. 4b) is homogeneous and does not display any drop in the intensity towards the long sides 42a, 42b and/or towards the short sides 43a and 43b. The detection light beam 12 coming from the specimen 10 is computed with the wavelength-dependent brightness distribution stored in the memory unit 15 in such a way that a homogeneously illuminated image field 40 is created. The detection light beam 12 coming from the specimen is detected pixel-by-pixel by the detector 20, which is a CCD chip. This data is fed to the electronic circuit 14 which then compares the stored wavelength-dependent brightness distribution to the measured wavelength-dependent brightness distribution as a function of the wavelength.

FIG. 2 shows the schematic structure of a scanning microscope 100 in which the idea according to the invention is implemented. The illuminating light beam 5 coming from at least one light source 3 is directed at an actuatable element 13. The illuminating light beam 5 coming from the actuatable element 13 is conducted to a scanning device 16. In the embodiment disclosed here, the scanning device 16 comprises a gimbal-mounted scanning mirror 18 that conducts the illuminating light beam 5 through a scanning lens 19 and through a lens 9 over or through a specimen 10. In case of a non-transparent specimen 10, the illuminating light beam 5 is conducted over the specimen surface. In the case of biological specimens 10 (preparations) or transparent specimens 10, the illuminating light beam 5 can also be conducted through the specimen 10. In order to increase the contrast, non-luminous preparations can optionally be prepared with a suitable dye (not shown, since this is the established state of the art). The dyes present in the specimen 10 are excited by the illuminating light beam 5 and emit light in a characteristic spectral range that is specific to them. This light coming from the specimen defines a detection light beam 12. It passes through the lens 9, the scanning lens 19 and, via the scanning device 16, reaches the actuatable element 13, traverses the latter without being influenced and, for example, via a detection pinhole 21, reaches at least one detector 20 that is configured as a photomultiplier. It is clear to the person skilled in the art that other detection components such as, for instance, diodes, diode arrays, photomultiplier arrays, CCD chips or CMOS image sensors can also be used. The detection light beam 12 coming from or defined by the specimen 10 is shown in FIG. 2, like in FIG. 1, as a broken line. Electric detection signals that are proportional to the output of the light coming from the specimen 10 are generated in the detector 20. Since, as already mentioned above, the specimen 10 does not emit light of only one wavelength, it is advantageous to install a selection means for the spectrum coming from the sample 10 upstream from the at least one detector 20. In the embodiment shown here, the selection means is an SP module 23. The SP module 23 is configured in such a way that it can capture an entire lambda scan, that is to say, that all of the wavelengths emitted by the light source 3 can be recorded. By the same token, several of the wavelengths coming from the specimen 10 can be spatially separated and, if applicable, can also be recorded parallel in time. The data generated by the detector 20 is forwarded to the electronic circuit 14. At least one peripheral device 27 is associated with the electronic circuit 14. This peripheral device 27 can be, for example, a display on which the user receives information about the setting of the scanning microscope or about the current setup and can also obtain the image data in graphic form. Moreover, the memory unit 15 is connected to the electronic circuit 14 and, as already described, this is where the wavelength-dependent brightness distribution—shown, for example, in FIG. 4b—of the illumination field 46 of the lenses 9 present in the microscope system 1 is saved.

The SP module 23 spatially, spectrally splits the detection light beam 12 with a prism 31. Another possibility for spectral splitting is the use of a reflecting diffraction grating or a transmission diffraction grating. The spectrally split light fan 32 is focused with the focusing lens 33 and subsequently strikes a mirror diaphragm arrangement 34, 35. The mirror diaphragm arrangement 34, 35, the means for spectral, spatial splitting, the focusing lens 33 and the detectors 36 and 37 are referred to together as the SP module 23 (or multi-band detector).

The scanning device 16 conducts the illuminating light beam 5 pixel-by-pixel over or through the specimen 10. The actuatable element 13 in the illuminating light beam 5 is an acousto-optic element that can be actuated as a function of the wavelength-dependent brightness distribution saved in the memory unit 15 in such a way that the illumination field 46 consisting of the individual pixels has a homogenous brightness distribution. The acousto-optic element 13 is an AOTF (Acousto-Optic Tunable Filter) or an AOBS (Acousto-Optic Beam Splitter) or an AOM (Acousto-Optic Modulator). The light source 3 consists of at least one laser that generates the illuminating light beam 5. The at least one laser can be a multiline laser. By the same token, it is conceivable for the laser to emit a continuous wavelength spectrum so that the specimen 10 is either illuminated with a continuous wavelength spectrum or the user selects any desired wavelengths from the continuous wavelength spectrum in order to illuminate the specimen 10.

FIG. 3 shows a schematic depiction of another embodiment of the scanning microscope 100 with a control circuit 60 for changing the intensity of the illuminating light beam 5 coming from the light source 3. The same elements as already described for FIG. 2 are designated with the same reference numerals. The light source 3, which is configured as a multiline laser, is provided with the control circuit 60 so that the intensity of the illumination light being emitted by the laser is controlled as a function of the stored wavelength-dependent brightness distribution. The illumination field 46 (see FIG. 4b) is then illuminated homogeneously and does not exhibit any drop in the intensity towards the long sides 42a, 42b and/or towards the short sides 43a, 43b. The dyes present in the specimen 10 are excited by the illuminating light beam 5 and emit light in a characteristic spectral range that is specific to them. This light coming from the specimen defines a detection light beam 12. It passes through the lens 9, the scanning lens 19 and, via the scanning device 16, reaches a wavelength-selective element 63, traverses the latter without being influenced and, for example, via a detection pinhole 21, reaches at least one detector 20 that is configured as a photomultiplier. Other embodiments of the detector were already mentioned in the description pertaining to FIG. 2.

FIG. 5 shows a schematic depiction of the detector 20 which, in this embodiment, is configured as an area sensor 44 in order to detect the detection light beam 12 coming from the specimen 10. The area sensor 44 comprises multiple pixels 45_{1,1}, 45_{1,2}, 45_{1,3}, . . . , 45_{n,m-1}, 45_{n,m}, which are arranged on a surface. The light coming from the specimen 10 is imaged by the lens 9 onto the area sensor 44. The individual pixels 45_{1,1}, 45_{1,2}, 45_{1,3}, . . . , 45_{n,m-1}, 45_{n,m} register the intensity, which is superimposed on the shading effect of the lens 19. The wavelength-dependent brightness distribution is saved in the memory unit 15 and the electronic circuit 14 compares the data captured by the detector 20 to the wavelength-dependent brightness distribution, so that the captured image field 40 is homogeneously illuminated at the wavelength λₙ.

FIG. 6 shows a schematic depiction of the actuatable element 13 where the individual pixels 50_{1,1}, 50_{1,2}, 50_{1,3}, . . . , 50_{n,m-1}, 50_{n,m} are actuated according to the brightness distribution for a given wavelength. Generally speaking, the gray values associated with the pixels 50_{1,1}, 50_{1,2}, 50_{1,3}, . . . , 50_{n,m-1}, 50_{n,m} constitute the shading effect caused by the lens 9. This is the negative depiction for the actuation of the individual pixels 50_{1,1}, 50_{1,2}, 50_{1,3}, . . . , 50_{n,m-1}, 50_{n,m}. This means that the pixels 50_{1,1}, 50_{1,2}, 50_{1,3}, . . . , 50_{n,m-1}, 50_{n,m} are actuated inversely as a function of the gray value, that is to say, the darker the pixels 50_{1,1}, 50_{1,2}, 50_{1,3}, . . . , 50_{n,m-1}, 50_{n,m} are, the less the shading caused by the actuation is. As already mentioned, the actuation of the actuatable element 13 is such that the illumination field 46 on the specimen 10 is homogeneously illuminated.

A laser beam illuminates the specimen 10 in a meander-like manner, so that the specimen 10 is illuminated, that is to say, the illumination field is covered consecutively with a plurality of image points. A scanning device 16 conducts the illuminating light beam 5 pixel-by-pixel over or through the specimen 10 in order to yield a homogeneously illuminated illumination field 46; the actuatable element 13 in the illuminating light beam 5 is an acousto-optic element 13. As shown in the depiction of FIG. 5, the acousto-optic element 13 is likewise actuated inversely. This means that the greater the gray value due to the shading is, the higher the intensity of the laser beam has to be when it reaches this position. This takes place as a function of the wavelength-dependent brightness distribution saved in the memory unit 15 in such a way that the illumination field 46 consisting of the individual pixels has a homogenous brightness distribution.

As already mentioned, the shading effect occurs. The shading effect can be described by f(x, y, λ). Here, x is the X-position and y is the Y-position of the individual pixel in the illumination field. It is especially advantageous for the wavelength-dependent brightness distribution to be depicted as a model. The wavelength-dependent brightness distribution or the attenuation for each wavelength can be expressed as a functional. Here,
F(x,y)=a+bx+cy+dxy+ex²+fy²
is seen as a good approximation, whereby the coefficients depend on the wavelength. The following applies: a(λ), b(λ), c(λ), d(λ), e(λ), f(λ). It is sufficiently familiar to a person skilled in the art that higher polynomial models can also be used. An illumination pattern that corrects the shading effect is then:
G(x,y)=F⁻¹(x−x0,y−y0)
which, in this context, raises the illumination characteristics where the lens causes a damping, while the shift x0, y0 stands for the quality of the adjustment. If the laser does not run towards at the specimen 10 centrally in the illumination field 46, then this misalignment can also be taken into account in the determination of the wavelength-dependent brightness distribution. The system then uses the appropriate correction for the illumination of the specimen 10.

1-33. (canceled)

34. A microscope system comprising:
at least one lens configured to define an illumination field;
at least one light source configured to emit an illuminating light beam for illuminating a specimen through the lens;
at least one detector configured to, pixel-by-pixel, detect a detection light beam coming from the specimen;
an electronic circuit connected downstream from the detector, the electronic circuit including a memory unit configured to store a wavelength-dependent brightness distribution of an illumination field of the at least one lens, the electronic circuit configured to employ, pixel-by-pixel, the stored wavelength-dependent brightness distribution so as to form a homogeneously illuminated image field; and
an actuatable element configured to control, pixel-by-pixel, an intensity of the illuminating light beam as a function of the stored wavelength-dependent brightness distribution so as to homogeneously illuminate the illumination field.

35. The microscope system as recited in claim 34 wherein the actuatable element includes a control circuit configured to directly control the intensity of the illuminating light beam as a function of the stored wavelength-dependent brightness distribution.

36. The microscope system as recited in claim 34 wherein the actuatable element is disposed in the illuminating light beam.

37. The microscope system as recited in claim 36 wherein:
the actuatable element includes an LCD matrix having individual pixels configured to be actuated according to the stored wavelength-dependent brightness distribution; and
the detector includes a CCD chip.

38. The microscope system as recited in claim 34 further comprising a scanning device disposed in the illuminating light beam and configured to conduct, pixel-by-pixel, the illuminating light beam over or through the specimen.

39. The microscope system as recited in claim 34 wherein the actuatable element includes an acousto-optic element configured to be actuated as a function of the stored wavelength-dependent brightness distribution so that the illumination field has a homogeneous brightness distribution.

40. The microscope system as recited in claim 39 wherein the acousto-optic element includes at least one of an AOTF, an AOBS and an AOM.

41. The microscope system as recited in claim 34 wherein the at least one light source includes at least one laser.

42. The microscope system as recited in claim 41 wherein the at least one laser includes a multiline laser.

43. The microscope system as recited in claim 41 wherein the at least one laser is configured to emit a continuous wavelength spectrum.

44. The microscope system as recited in claim 39 wherein:
the detector includes at least one light-sensitive element configured to serially capture pixels of the illumination field on the specimen; and
the electronic circuit is configured to combine the pixels so as to form the image field, the image field being computable with the wavelength-dependent brightness distribution.

45. The microscope system as recited in claim 44 wherein the detector includes an SP module having at least one light-sensitive element.

46. The microscope system as recited in claim 34 wherein the electronic circuit includes a Field-Programmable Gate Array.

47. The microscope system as recited in claim 34 wherein the electronic circuit is implemented in a personal computer associated with the microscope.

48. The microscope system as recited in claim 34 wherein the wavelength-dependent brightness distribution includes a model.

49. The microscope system as recited in claim 48 wherein the wavelength-dependent brightness distribution is approximated as a polynomial of a higher order and respective coefficients of the model are approximated as a spline function or as a differently modeled spectral function.

50. A method for the shading correction of at least one lens of a microscope system, the at least one lens defining an illumination field, the microscope system including at least one light source and at least one detector, the at least one light source being configured to emit an illuminating light beam for illuminating a specimen through the lens, the method comprising:
storing a wavelength-dependent brightness distribution of the illumination field in a memory unit of an electronic circuit;
actuating, pixel-by-pixel, an actuatable element with the wavelength-dependent brightness distribution so as to illuminate the illumination field homogeneously;
detecting, pixel-by-pixel, a detection light beam coming from the specimen; and
employing the wavelength-dependent brightness distribution on an image field captured with the lens.

51. The method as recited in claim 50 further comprising determining the wavelength-dependent brightness distribution using the detector in a pixel-by-pixel manner for each of the at least one lens.

52. The method as recited in claim 50 wherein the actuatable element includes a control circuit, and further comprising directly controlling an intensity of the illuminating light beam as a function of the stored wavelength-dependent brightness distribution.

53. The method as recited in claim 50 wherein the actuatable element is disposed in the illuminating light beam.

54. The method as recited in claim 50 wherein the actuatable element includes an LCD matrix and wherein the detector includes a CCD chip, and further comprising determining a wavelength-dependent brightness distribution of the image field using the CCD chip.

55. The method as recited in claim 50 further comprising disposing a scanning device in the illuminating light beam, and conducting the illuminating light beam pixel-by-pixel over or through the specimen using the scanning device.

56. The method as recited in claim 50 wherein the actuatable element includes an acousto-optic element and wherein the actuating includes actuating the acousto-optic element as a function of the saved wavelength-dependent brightness distribution so that the illumination field has a homogeneous brightness distribution on or in the specimen.

57. The method as recited in claim 56 wherein the acousto-optic element includes at least one of an AOTF, an AOBS and an AOM.

58. The method as recited in claim 50 wherein the light source includes at least one laser.

59. The method as recited in claim 58 wherein the at least one laser includes a multiline laser.

60. The method as recited in claim 58 wherein the at least one laser is configured to emit a continuous wavelength spectrum.

61. The method as recited in claim 50 wherein the at least one detector includes at least one light-sensitive element, and further comprising serially capturing pixels of the illumination field on the specimen and, using the electronic circuit, combining the individual pixels so as to form the image field.

62. The method as recited in claim 61 wherein the detector includes an SP module having at least one light-sensitive element.

63. The method as recited in claim 50 wherein the electronic circuit includes a Field-Programmable Gate Array.

64. The method as recited in claim 50 wherein the electronic circuit is implemented in a personal computer associated with the microscope system.

65. The method as recited in claim 50 wherein the wavelength-dependent brightness distribution includes a model.

66. The method as recited in claim 65 wherein the wavelength-dependent brightness distribution is approximated as a polynomial of a higher order and respective coefficients of the model are approximated as a spline function or as a differently modeled spectral function.
